(19) United States
(12) Patent Application Publication
(10) Pub. No.: US 2013/0256445 A1
(43) Pub. Date: Oct. 3, 2013

(54) Safety belt retractor having a pretensioning device

(71) Applicants: Andreas Lucht, Horst (DE); Geert-Helge Wiffenberg, Norderstedt (DE); Frank Matzen, Hamburg (DE); Erik Ziel, Quickborn (DE); Peer Gross, Hamburg (DE); Yogel Patel, Alingsas (SE)

(72) Inventors: Andreas Lucht, Horst (DE); Geert-Helge Wiffenberg, Norderstedt (DE); Frank Matzen, Hamburg (DE); Erik Ziel, Quickborn (DE); Peer Gross, Hamburg (DE); Yogel Patel, Alingsas (SE)

(73) Assignee: Autoliv Development AB

(21) Appl. No.: 13/143,236

(22) Filed: Jul. 5, 2011

Related U.S. Application Data
(63) Continuation-in-part of application No. 10/522,608, filed on Mar. 2, 2005, now abandoned.

(30) Foreign Application Priority Data
May 29, 2002 (DE) 102 24 236.4

(51) Int. Cl. B60R 22/46

(52) U.S. Cl. CPC B60R 22/46
USPC 242/390.8

(57) ABSTRACT

A safety belt retractor, especially for use in motor vehicles, is provided, and has a blocking system and a tensioning device, which acts on a belt shaft, for carrying out a reversible pretensioning of an occupant. A spiral toothing meshes with an external toothing of the belt shaft, and is supported against a fixed counter-bearing such that upon an axial loading of the spiral toothing directed against the counter-bearing due to load acting on the belt shaft in a belt withdrawal direction, rotation of the spiral toothing, for receiving torque applied by the belt shaft, is prevented via a support force. An electric motor is coupled to the belt shaft via the spiral toothing.

### CROSS-REFERENCE TO RELATED APPLICATION

The present application is a continuation-in-part of copending U.S. application Ser. No. 10/522,608, filed Mar. 2, 2010.

### BACKGROUND OF THE INVENTION

The invention relates to a safety belt retractor, especially for use in motor vehicles, having a blocking system that is controlled in a vehicle sensitive and/or belt strap sensitive manner, and also having a tensioning device, which acts on the belt shaft, for carrying out a reversible pretensioning of the occupants, whereby the belt shaft can be coupled with an electric motor, as a tensioner drive, via an interposed gear mechanism.

A safety belt retractor having the aforementioned features is known from EP 0 893 313 A2. An electric motor, which is rotatable not only in the belt unwinding direction but also in the belt winding direction, can be coupled to the belt shaft of the belt retractor; from the electric motor, via an interposed gear mechanism and as a function of certain driving situations, adjustable torques can be made to act upon the belt shaft. In this connection, in a predetermined shift position of the gear mechanism, the torque delivered by the electric motor can be transferred for tensioning the belt strap on the belt shaft. With regard to such a tensioning, with the known safety belt retractor a distinction is made between a so-called pretensioning and a performance tensioning. Within the scope of the so-call pretensioning, the strapped-in occupant, upon the occurrence of speed changes or deceleration values below the threshold for the triggering of the performance tensioning during an accident, is pulled via a reduced torque of the electric motor into his normal sitting position, and belt slack is removed from the safety belt. Since upon cessation of the change in speed the pretensioning is concluded, and as a reversible process can again be introduced upon the occurrence of a further appropriate driving situation, the strapped-in vehicle occupant has imparted to him a feeling of active security. If the triggering threshold for the performance tensioning is exceeded during an accident, the electric motor operates with an appropriately high torque.

In conjunction with the pretensioning of the safety belt, the disadvantageous situation of a self-blocking of the safety belt can occur in that via the pretensioning all belt slack is taken out of the safety belt system and the safety belt rests taughtly against the body of the strapped-in person, whereby depending upon the driving situation, at the end of the pretensioning process one cannot preclude that via a slight forward displacement of the body of the strapped-in occupant, the blocking disk of the blocking system on the side of the belt retractor will be brought into a load-transmitting engagement with a housing component. To the extent that in this blocking position of the blocking disk a return rotation of the belt shaft in the belt winding direction is permitted in order to bring the blocking disk out of its load-transmitting position, there must be effected in a disadvantageous manner, after conclusion of each reversible pretensioning, an additional post tensioning with a somewhat greater force than during the pretensioning, which leads to an undesired stressing of the system and/or reduction of the wear comfort for the vehicle occupant.

It is therefore an object of the invention, with a safety belt retractor having the aforementioned features, to prevent a premature activation of the blocking system and to thereby preclude a self-blocking.

### SUMMARY OF THE INVENTION

The basic concept of the invention is that as a gear mechanism for the connection of the belt shaft to the electric motor, a worm or spiral toothing is provided that meshes with an external toothing of the belt shaft, whereby the spiral toothing is supported against a fixed counter-bearing such that upon the occurrence of an axial loading of the spiral toothing directed against the counter-bearing due to a load acting upon the belt shaft in the belt withdrawal direction, a rotation of the spiral, for receiving a torque applied by the belt shaft, is prevented via a support force.

To the extent that the invention proposes a spiral toothing as a transmission step for the transfer of the drive movement of the electric motor to the belt shaft, the inventive concept also involves, by means of a suitable design of the spiral toothing or by means of other measures at the conclusion of the tensioning movement via a rotation of the belt shaft in the belt winding direction, the prevention of a reversal of the belt shaft, due to a load acting upon the belt shaft in the belt withdrawal direction, by preventing the rotation of the spiral toothing in the appropriate direction of rotation to such an extent that the torque applied by the belt shaft is absorbed without permitting a reversal of the belt shaft. This prevents an activation of the blocking system in an advantageous manner. In this connection, the spiral toothing is configured in such a way that in the one direction of rotation of the spiral toothing, namely in the tensioning direction in conformity with the belt winding direction, the efficiency of the gear mechanism can be fully utilized, whereas in the opposite direction of rotation, in other words in conformity with the belt withdrawal direction, preventing rotation of the spiral is brought about in that the spiral toothing is supported against a fixed counter-bearing in such a way that with an axial loading of the spiral toothing directed against the counter-bearing due to the belt shaft, the prevention of the rotation of the spiral is brought about by the support force. To the extent that at the conclusion of pretensioning of the belt shaft a torque acts upon the spiral toothing, this leads to an axial loading of the spiral toothing that can be converted into an appropriately acting support force.

To the extent that pursuant to EP 0 893 313 A2 a performance tensioning is also provided in the event of a crash, the use of an electric motor having a gear mechanism embodied as a spiral toothing is also not precluded for the performance tensioning to the extent that the electric motor is designed to apply an appropriate torque. However, the performance tensioning can also be effected via another tensioner drive that acts upon the belt shaft, or via a tensioner, for example a buckle tensioner, which is disposed in some other region of the safety belt system.

Pursuant to one embodiment of the invention, the spiral toothing is coupled via a miter-wheel gearing to a drive shaft of the electric motor. This involves an especially space-saving manner of construction of the safety belt retractor, because the electric motor can be disposed directly over the shaft portion of the safety belt retractor.

To the extent that pursuant to one embodiment of the invention a crown wheel gear mechanism is provided as a miter-wheel gearing, this results in production advantages. Alternatively, however, the arrangement of a bevel gearing is also conceivable, whereby the tolerance zone positions of a bevel gearing can be controlled only at great expense during mass production. In so far, however, the use of a bevel gearing to realize the invention is not precluded.

Pursuant to an embodiment of the invention, the spiral toothing is formed on a carrier shaft, and the carrier shaft is connected to the miter-wheel gearing.

The prevention of the spiral rotation can be carried out pursuant to an embodiment of the invention in that disposed between the counter-bearing and the first land or thread of the spiral toothing is a component that increases friction. The friction-increasing component can, pursuant to an embodiment of the invention, be embodied as an intermediate or spacer disk of a material having a non-linear coefficient of friction; for example elastomers are in particular available that as the effect of force increases, an exponentially increasing frictional force occurs.

Alternatively, a bearing disk can be provided that deforms axially and elastically as the load increases, so that the first thread of the spiral toothing, under the effect of the support force, runs on a larger diameter in the bearing than without the effect of the support force.

Pursuant to a further embodiment of the invention, the surface of the gear mechanism that faces the spiral toothing is provided with a conical recess, and disposed on the carrier shaft is the conical friction body that is made of an elastic material and has a corresponding shape; in this embodiment, the increase of the friction force is effected by the conical shape of the recess and of the friction body, as well as by the elastic deformation.

Pursuant to a further alternative, a compression spring can be disposed between gear mechanism housing and spiral toothing, and carrier shaft and gear mechanism housing are provided with latching structures that interengage upon axial displacement of the carrier shaft;

instead of the compression spring, a tension spring can also be disposed at the appropriate end of the carrier shaft.

Pursuant to an embodiment of the invention, to achieve the prevention of the spiral rotation, the end face of the carrier shaft is supported against a shank of the drive shaft of the electric motor, so that in this way an appropriate braking moment is produced.

Alternatively, the crown wheel toothing of the crown wheel gear mechanism, which is effective between drive shaft of the electric motor and the carrier shaft for the spiral toothing, can have a multi-stage configuration such that with an axial loading of the carrier shaft, the transmission of the crown wheel gear mechanism changes, thus producing a braking moment for the rotation of the carrier shaft with the spiral toothing.

To the extent that the structural measures for preventing the spiral rotation are not yet adequate, to further absorb the torque emitted from the belt shaft, the electric motor can be designed with a further performance range for applying a holding moment that serves to aid in the prevention of the spiral rotation, so that in additional to the prevention of the spiral rotation by the electric motor, a blocking of the reversal of the spiral toothing in conformity with the withdrawal direction of the belt strap is applied via an appropriate holding moment.

Since, however, with the measures for the prevention of the reversal of the spiral toothing already adequate moments can be absorbed, the design of the electric motor with a performance range that serves for producing a holding moment additionally presents the possibility, during a force-limiting phase that is additionally provided with the aforementioned safety belt retractor, of establishing a controlled holding moment and hence of realizing an adaptive force limitation, for example together with a single stage or also multi-stage torsion rod. For this purpose, the holding moment of the electric motor can be adjustable by the motor control as a function of the load that acts on the belt shaft in the belt withdrawal direction.

With regard to the arrangement of the spiral toothing, pursuant to an embodiment of the invention the carrier shaft that carries the spiral toothing is held in a bearing at its end that is opposite the miter-wheel gearing, is mounted in an additional axial or thrust bearing that is surrounded by a bearing housing.

Expedient in this connection is the embodiment of the thrust bearing as a cup-shaped bearing because in so doing a deflection of the carrier shaft out of the axial starting position by a small angle is made possible, whereby again an increase of the gear mechanism friction in the context of the invention can be established.

To the extent that the mounting of the carrier shaft in an additional bearing housing is realized, it is expediently provided pursuant to an embodiment of the invention that the bearing housing form the counter-bearing for the spiral toothing.

### BRIEF DESCRIPTION OF THE DRAWINGS

Illustrated in the drawing are embodiments of the invention, which will be described subsequently. The drawing shows:

FIG. 1 an overall view of a safety belt retractor having a pretensioning device,

FIG. 2 the safety belt retractor of FIG. 1 in a side view of its tensioner side with pretensioning device,

FIG. 3 a side view of the pretensioning device of FIGS. 1 and 2 in a detailed illustration,

FIG. 4 a first embodiment of the prevention of the spiral rotation by support of the spiral toothing against the bearing housing in a diagrammatic illustration,

FIG. 5 the subject matter of FIG. 4 in a further embodiment,

FIG. 6 the subject matter of FIG. 4 in a further embodiment,

FIG. 7 the subject matter of FIG. 4 in a further embodiment,

FIG. 8 the subject matter of FIG. 4 in a further embodiment,

FIG. 9 a diagrammatic illustration of the prevention of the spiral rotation by utilization of the radial forces in the bearings of the carrier shaft,

FIG. 10 the prevention of the spiral rotation by support of the carrier shaft relative to the drive shaft of the electric motor,

FIG. 11 the prevention of the spiral rotation by support of the carrier shaft in the crown wheel gear mechanism; and

FIG. 12 a view showing the spiral toothing fixedly and non-displaceably disposed on the carrier shaft.

### DETAILED DESCRIPTION OF THE SPECIFIC EMBODIMENTS

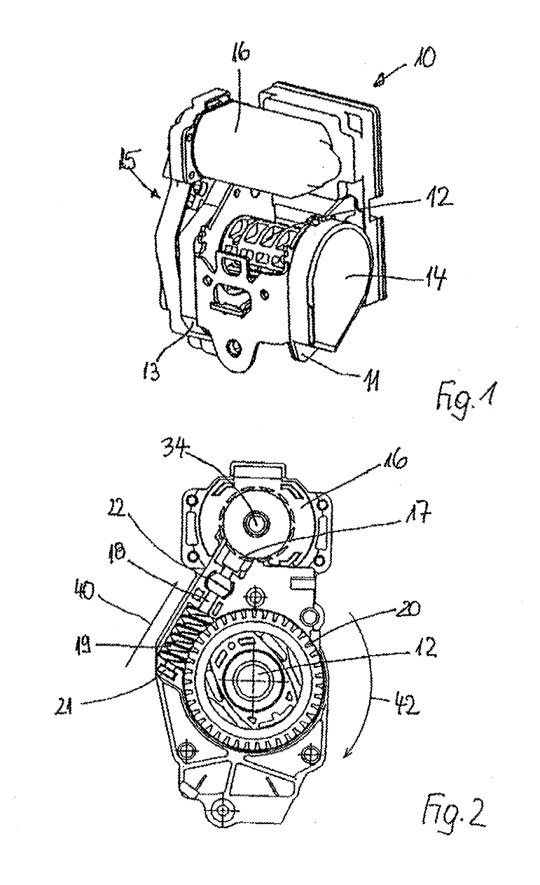

The safety belt retractor 10 seen in FIG. 1 has a U-shaped housing 11, in the U-legs of which a belt shaft 12 is mounted in a known manner. The belt shaft 12 is influenced by the action of a winding spring that is disposed in a spring cartridge 13 and which, after unwinding of the non-illustrated belt strap from the belt shaft 12, sees to it that the belt strap is rewound onto the belt shaft 12 when the safety belt is taken off. On the system side of the housing 11, which is not further illustrated in FIG. 1 and which is opposite the mounting of the spring cartridge 13, there is disposed, below the protective cover 14, the blocking system of the belt retractor that is not illustrated in detail and to this extent is presumed to be known; the function of the blocking system is to be controlled by control systems that act in a belt strap sensitive and/or vehicle sensitive manner.

On that side of the housing that is provided with the spring cartridge 13 a pretensioner housing is additionally indicated by the reference numeral 15; an electric motor 16, as a tensioner drive, is associated with the pretensioner housing.

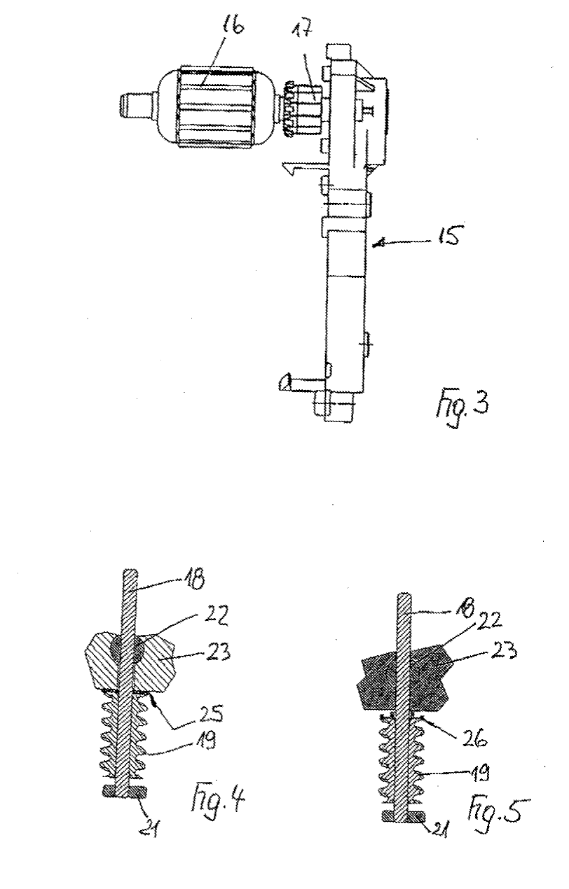

As can be seen in greater detail from FIGS. 2 and 3, the drive shaft 34 of the electric motor 16 acts via a crown wheel gear mechanism 17 upon a carrier shaft 18 that is disposed in a tangential orientation relative to the belt shaft 12; disposed on the carrier shaft is a worm or spiral toothing 19 that meshes with an external toothing 20 disposed on the belt shaft 12. The carrier shaft 18 is mounted in an end bearing 21 as well as in a cup-shaped bearing 22 that is disposed between the spiral toothing 19 and the crown wheel gear mechanism 17, whereby the cup-shaped bearing 22 is disposed in a bearing housing 23 that is not further illustrated in FIGS. 2 and 3 yet can be seen from FIGS. 4 to 8.

In the illustrated embodiment, the spiral toothing 19 is not embodied as a self-blocking spiral gear, so that by means of additional structural measures care is taken that with a load that at the conclusion of a pretensioning acts upon the belt shaft 12, in the belt withdrawal direction (arrow 42) the axial force (arrow 40) that is applied by the belt shaft 12 onto the spiral toothing 19, and hence onto the carrier shaft 18, is converted into a friction-increasing support force, so that in this way an arresting or preventing of the rotational movement of the spiral toothing 19 is brought about.

Embodiments for effecting the increase of the frictional force are primarily illustrated in FIGS. 4 to 8, whereby with the embodiment illustrated in FIG. 4 an intermediate or spacer disk 25, which is made of a material having a non-linear frictional coefficient, is disposed between the first land or thread of the spiral toothing 19 and the bearing housing 23 of the cup-shaped bearing 22. This material can be a suitable elastomer with which, as the axial force increases, the frictional force increases exponentially. FIG. 4 also shows that the shaft 18 and the threads 49 are combined into one integral unit.

The bearing disk 26 that pursuant to FIG. 5 is disposed between the spiral toothing 19 and the bearing housing 23 acts in a similar manner, according to which under the effect of the axial force (arrow 40) the spiral toothing runs on a larger diameter in the bearing than under normal load.

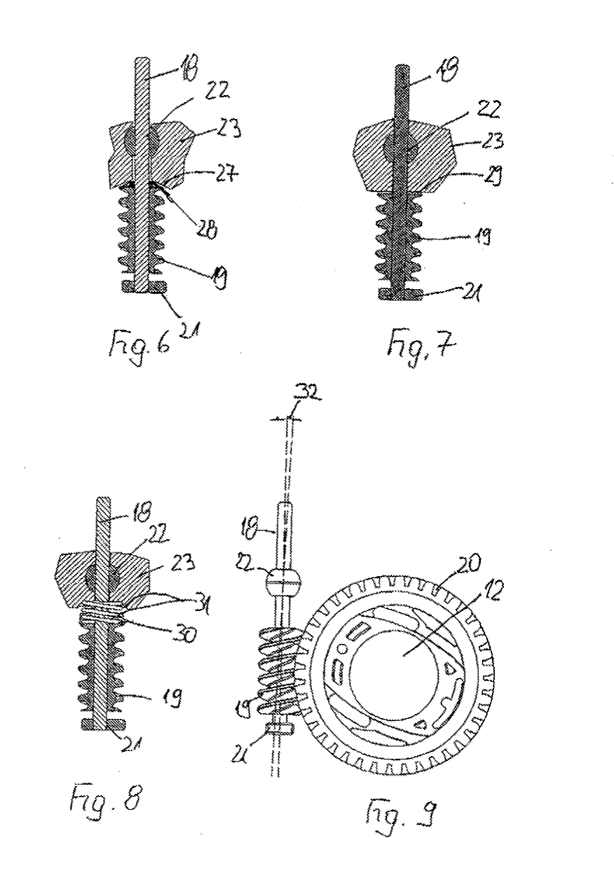

With the embodiment illustrated in FIG. 6, the bearing housing 23 is provided with a conical recess 27 into which engages a conical friction body 28 that has a corresponding shape and is made of an elastic material, so that due to the conical shape, as well as the elastic deformation of the friction body 28, the frictional force between the spiral toothing 19 and the bearing housing 23 is increased.

In the same manner, in the embodiment illustrated in FIG. 7, there is disposed between the spiral toothing 19 and the bearing housing 23 a sheet-like disk 29 that under the effect of force is elastically deformed, so that the frictional surface is increased and the frictional resistance increases. Alternatively, it would also be possible to realize a so-called “Knackfrosch” approach.

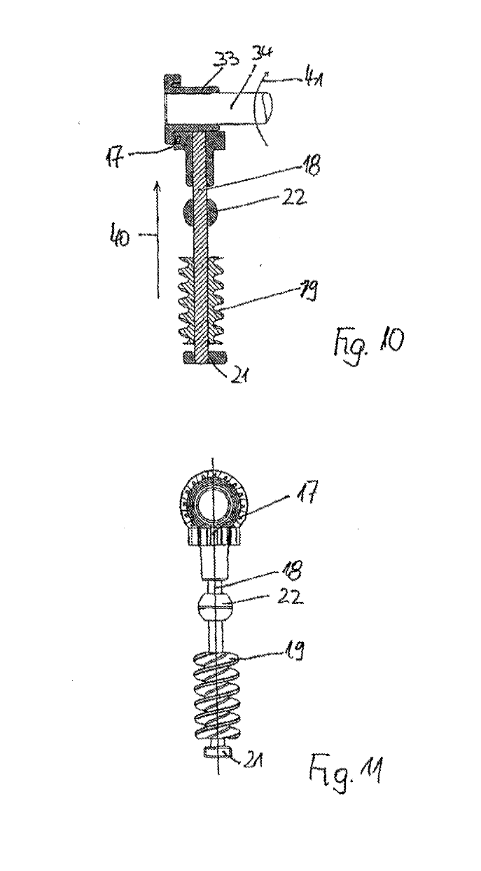

With the embodiment illustrated in FIG. 8, there is disposed between the bearing housing 23 and the spiral toothing 19 a compression spring 30, whereby in addition a positive connection means 31 is provided between the bearing housing 23 and the first land or thread of the spiral toothing 19, so that upon the influence of force (arrow 40) the spring 30 is compressed until the positive connection means 31 interlock.

FIG. 9 illustrates the possibility of increasing the frictional force between the spiral toothing 19 and the external toothing 20 of the belt shaft 12 in that with the influence of an axial force upon the carrier shaft 18, the latter tilts by a small angle 32 in the cup-shaped bearing 22.

FIG. 10 illustrates the possibility that the end face of the carrier shaft 18 is supported upon a shank 33 of the drive shaft 34 of the electric motor 16, thereby producing an appropriate braking moment.

FIG. 11 indicates that the crown wheel toothing of the crown wheel gear mechanism 17 that is effective between the drive shaft 34 of the electric motor 16 and the carrier shaft 18 has a multi-stage configuration such that with an axial loading of the carrier shaft (arrow 40), the transmission of the crown wheel gear mechanism 17 changes from rapid to slow, whereby alternatively or in addition an impairment of the toothing efficiency in the stages of the crown wheel gear mechanism 17 can be provided.

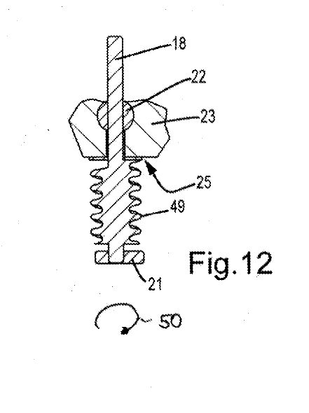

FIG. 12 shows that the spiral toothing 19 is fixedly disposed, or non-displaceably disposed, on the carrier shaft 18. Pursuant to the present invention, the electric motor 16 brings about rotation of the carrier shaft 18, on which is fixedly disposed a worm or spiral toothing 19, for driving the belt shaft 12 in the belt retraction direction when a tensioning process is initiated. When at the conclusion of the tensioning process, under the load of the strapped-in occupant, the direction of rotation of the belt shaft reverses into a rotation in the belt extension or unwinding direction, this rotation of the carrier shaft 18 with the spiral toothing 19 is to be prevented pursuant to the present invention. Since the spiral toothing 19 is fixedly disposed on the carrier shaft 18, it must be ensured that in the one direction of rotation of the fixed spiral toothing 19, in other words in the belt retraction direction, a free rotation of the spiral toothing 19 is possible, whereas the rotation of the spiral toothing 19 in the other direction of rotation, in other words in the belt unwinding direction, is blocked.

This blocking of the spiral toothing 19 in only one direction of rotation is inventively realized in that the leading or first thread of the threads 49 of the spiral toothing 19, as viewed in the direction of rotation of the spiral toothing 19 in the belt withdrawal direction, rests against a friction-increasing component 25, 26, 28, 29, 30 that is disposed between the counter-bearing 23 and the first thread of the spiral toothing 19, so that upon beginning of rotation of the spiral toothing 19 in the belt withdrawal direction, the spiral toothing 19 is blocked or prevented in this direction of rotation (arrow 50).

Pursuant to the present application, after the conclusion of a tensioning process, with rotation of the belt shaft in the belt retraction direction, the function of the friction-increasing component is to immediately prevent a turning back of the belt shaft in the belt withdrawal direction. The first thread of the fixedly disposed spiral toothing therefore always and continuously rests against the friction-increasing component, which in turn is supported against the counter-bearing 23.

The function or movement of the spiral toothing during the pretensioning process and at the end of the pretensioning process enables the first tooth of the spiral toothing to be in contact with the counter-bearing, such that due to a direction of lead of the spiral toothing, a rotation of the spiral toothing 19 in a pretensioning direction is enabled and rotation of the spiral toothing in a direction opposite to said pretensioning direction is prevented by exertion of the load.

Thus, the spiral toothing is either formed as one-piece on the profile of the carrier shaft (see FIG. 4) or can be fixedly connected to the carrier shaft as a separate component, for example in a press fit manner.

Of course, the carrier shaft 18 is—and must be—non-displaceably disposed apart from the manufacturing tolerances, so that a corresponding force transfer from the crown gear 17 to the outer toothing 20 of the belt shaft 12 is possible. This technical teaching of the present invention relates to the principle that the carrier shaft 18 and the spiral toothing 19 both are disposed non-displaceably so that a fixed connection to the drive shaft 34 via the crown gear 17 on the one hand and to the outer toothing 20 of the belt shaft 12 on the other hand are provided.

The features of the subject matter of these documents disclosed in the preceding description, the patent claims, the abstract and the drawing can be important individually as well as in any combination with one another for realizing the various embodiments of the invention.

The specification incorporates by reference the disclosure of German priority document 102 24 236.4 filed May 29, 202 and PCT/EP03/05545 filed May 27, 2003.

The present invention is, of course, in no way restricted to the specific disclosure of the specification and drawings, but also encompasses any modifications within the scope of the appended claims.

1. A belt shaft retractor having a blocking system that is controlled in a vehicle sensitive and/or belt strap sensitive manner, comprising:
a belt shaft (12);
a tensioning device that acts on the belt shaft (12) and is configured for carrying out a reversible pretensioning of a vehicle occupant;
a carrier shaft having a spiral toothing (19) and that meshes with an external toothing (20) of the belt shaft (12), wherein said spiral toothing is fixedly and non-displaceably disposed on said carrier shaft;
an electric motor (16) as a drive for the tensioning device, wherein said electric motor is adapted to be coupled to said belt shaft (12) via said spiral toothing (19), wherein said electric motor is adapted to act upon the carrier shaft (18), wherein the electric motor (18) is further adapted to rotate the carrier shaft in a first rotation direction during the pretensioning, and wherein said spiral toothing (19) and said external toothing (20) when meshed are not self-locking to facilitate rotation of the carrier shaft during pretensioning;
a fixed counter-bearing (23) configured as means to prevent said reversal of said first rotation direction of said carrier shaft, wherein said spiral toothing (19) is supported indirectly against said counter-bearing such that upon an occurrence of an axial loading of said spiral toothing (19) directed toward said counter-bearing (23) due to a load exerted on said belt shaft (12) in a belt withdrawal direction by a vehicle occupant after completion of pretensioning, a rotation of said spiral toothing is prevented via a supporting force,
a frictional component (25, 26, 28, 29, 30) disposed between said counter-bearing (23) and a first thread of said spiral toothing (19) for increasing a level of friction between said counter-bearing (23) and said first thread of said spiral toothing (19) until said level of friction is sufficient to prevent further movement and rotation of the carrier shaft upon a reversal in a direction of rotation of said carrier shaft after completion of the pretensioning,
wherein only the first thread of the spiral toothing (19) on an end of the spiral toothing is in contact with said frictional component and acts in an axial direction against the frictional component to produce an axial component in a rotational force, wherein said axial component counteracts the supporting force as a reaction force,
wherein due to a direction of lead of the spiral toothing, a rotation of the spiral toothing (19) in a pretensioning direction is enabled and rotation of the spiral toothing in a direction opposite to said pretensioning direction is prevented by exertion of said load.

2. A safety belt retractor according to claim 1, wherein said spiral toothing (19) is coupled to a drive shaft (34) of said electric motor (16) via a miter-wheel gearing (17).

3. A safety belt retractor according to claim 2, wherein said miter-wheel gearing (17) is embodied as a crown wheel gear mechanism (17).

4. A safety belt retractor according to claim 2, wherein said spiral toothing (19) is formed on a carrier shaft (18), and wherein said carrier shaft (18) is connected to the miter-wheel gearing (17).

5. A safety belt retractor according to claim 1, wherein said frictional component is a spacer disk (25) of a material having a non-linear coefficient of friction, such that as axial forces applied on said spacer disk increase, frictional forces increase exponentially.

6. A safety belt retractor according to claim 1, wherein said friction-increasing component is a bearing disk (26) that deforms axially and elastically as load increases.

7. A safety belt retractor according to claim 1, wherein a surface of said counter-bearing (23) that faces said spiral toothing (19) is provided with a conical recess (27), and wherein disposed on said carrier shaft (18) is a conical friction body (28) that has a corresponding shape and is made of an elastic material.

8. A safety belt retractor according to claim 1, wherein a compression spring (30) is disposed between said counter-bearing (23) and said spiral toothing (19), and wherein said carrier shaft (18) and said counter-bearing (23) are provided with latching structures (31) that interlock during an axial displacement of said carrier shaft (18).

9. A safety belt retractor according to claim 1, wherein said spiral toothing (19) is formed on a carrier shaft (18), and wherein an end face of said carrier shaft is supported against a shank (33) of a drive shaft (34) of said electric motor (16).

10. A safety belt retractor according to claim 1, wherein a crown wheel toothing of a crown wheel gear mechanism (17) that is effective between a drive shaft (34) of said electric motor (16) and a carrier shaft (18) on which is formed said spiral toothing (19) has a multi-stage configuration such that during an axial loading of said carrier shaft (18), a transmission of said crown wheel gear mechanism (17) changes.

11. A safety belt retractor according to claim 1, wherein said electric motor (16) has a performance range for applying a holding moment to aid in prevention of rotation of said spiral toothing (19).

12. A safety belt retractor according to claim 11, wherein said holding moment of said electric motor (16) is adjustable via a motor control as a function of load acting on said belt shaft (12) in a belt withdrawal direction.

13. A safety belt retractor according claim 4, wherein said spiral toothing is formed on an end of said carrier shaft (18) opposite said miter-wheel gearing, wherein said carrier shaft is held in a first bearing (21), and wherein in a region between said spiral toothing (19) and said miter-wheel gearing (17) said carrier shaft (18) is mounted in a thrust bearing (22) that is surrounded by said fixed counter-bearing in the form of a bearing housing (23).

14. A safety belt retractor according to claim 13, wherein said thrust bearing is embodied as a cup-shaped bearing (22).

15. A safety belt retractor according to claim 13, wherein said bearing housing (23) forms said counter-bearing for said spiral toothing (19).
